(19) United States
(12) Patent Application Publication
(10) Pub. No.: US 2022/0032333 A1
(43) Pub. Date: Feb. 3, 2022

(54) FIXING STRUCTURE FOR FLUSHING DEVICE

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN)

(73) Assignee: Purity (Xiamen) Sanitary Ware Co., Ltd., Xiamen City (CN)

(21) Appl. No.: 16/983,737

(22) Filed: Aug. 3, 2020

(51) Int. Cl. B05B 15/62

(52) U.S. Cl. CPC B05B 15/62

(57) ABSTRACT

A fixing structure for flushing devices, including a fixed seat, a guiding connection part, a first magnetic part, and a second magnetic part. The fixed seat has two opposite ends; one is fixed to a fixed plane, while the other has a recess. The first magnetic part is provided in the recess; the guiding connection part is provided on the flushing device to connect the flushing head and an outlet pipe. The second magnetic part is provided on the guiding connection part; when the guiding connection part is close to the recess, the second magnetic part magnetically attract the first magnetic part. The first magnetic part and the second magnetic part are magnets or magnetic. Therefore, users can connect the guiding connection part with the fixed seat without exerting a force. Furthermore, the fixing structure can be magnetically attracted to positioning without visual confirmation, which is more convenient to use.

### BACKGROUND OF THE INVENTION

### 1. Technical Field

The present invention relates generally to a fixing structure, and more particularly to a fixing structure for flushing device.

### 2. Description of Related Art

There are a variety of flushing devices on the market, wherein the most commonly used devices are sanitary equipment with flushing heads and water supply pipes, such as sprinklers, shower heads, and cleaner spray guns.

It is known that the abovementioned sanitary equipment adopts the design with a fixed seat which has an opening formed on the top to be mounted by a guiding connection part. While using the flushing devices, a user has to align the guiding connection part to the opening, and then exert a force on the guiding connection part to make the guiding connection part fitted in the opening, so that the guiding connection part is fixed to the fixed seat. Thus, the flushing devices can be fixed on the wall and other planes.

However, when using the fixed seat mentioned above, a user has to ensure that the guiding connection part is embedded into the opening, and the deviation of their relative positions would not be excessive. In this situation, if the user is unable to see (e.g., the user is blind, with amblyopia, or the visual field is covered when taking a shower), it would not be easy for the user to fit the guiding connection part of the sprinkler, the shower head, or the cleaner spray gun into the fixed seat. Moreover, the protruding part of the opening of the fixed seat could be fractured or deformed by long-term repeated force, which makes the fixed seat lose the function of fixing. The above defects increase the difficulty of using the flushing devices.

From the above, the design of the conventional fixing structure, which makes a user must visually align before positioning and fixing the fixing structure, needs to be improved.

### BRIEF SUMMARY OF THE INVENTION

In view of the above, the primary objective of the present invention is to provide a fixing structure making a flushing device such as a sprinkler, a shower head, or a cleaner spray gun be fixed on a fixed seat easily, wherein a user doesn't have to exert a force and align the guiding connection part to the opening.

The present invention provides a fixing structure for flushing devices, which includes a fixed seat, a guiding connection part, a first magnetic part, and a second magnetic part. The fixed seat has two ends which are opposite to each other, wherein one of the two ends is fixed to a fixed plane, while the other of the two ends has a recess; the fixed seat further comprises a first magnetic part provided on the recess. A common flushing device includes a guiding connection part and a flushing head. An end of the guiding connection part is connected to the flushing head, while another end of the guiding connection part is connected to a water supply pipe, which makes the water supply pipe communicate with the flushing head so that the flushing head can be controlled to make water flow out. The second magnetic part is provided on the guiding connection part; when the guiding connection part is close to the recess of the fixed seat, the second magnetic part and the first magnetic part can magnetically attract each other. One of the first magnetic part and the second magnetic part is a magnet, while the other of the first magnetic part and the second magnetic part is a magnetic material or another magnet.

The present invention adopts a different joining method from the conventional fixing structure, and provides a larger joint range and positioning space, which increases the convenience of use.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the flushing device of the first embodiment of the present invention;

FIG. 2 is a front view of the flushing device in FIG. 1;

FIG. 3 is an exploded view of the flushing device in FIG. 1;

FIG. 4 is a sectional view along the 4-4 line in FIG. 2;

FIG. 5 is a schematic diagram showing the combination of the shallow groove 16 and the magnetic tile 12b of the first embodiment;

FIG. 6 is a perspective upward view of partial of the first embodiment, which is embodied by an embedded way;

FIG. 7 is a schematic diagram of the second magnetic part 14 of the second embodiment, which is embodied by fitting around;

FIG. 8 is a schematic diagram of the second magnetic part 14 of the third embodiment, which is ring-shaped and embedded with the guiding connection part 20;

FIG. 9 is a schematic diagram of the notch 26 formed on the peripheral surface 22 of the guiding connection part of the fourth embodiment; and

FIG. 10 is a schematic diagram of the second magnetic part 14 of the fifth embodiment fixed on the inner surface 24 of the guiding connection part.

### DETAILED DESCRIPTION OF THE INVENTION

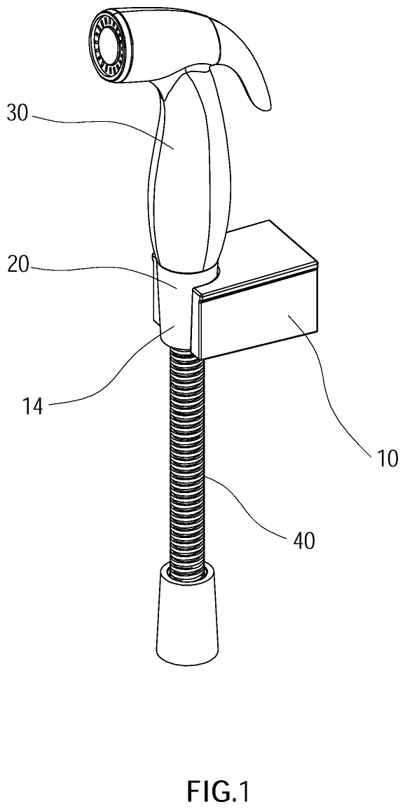

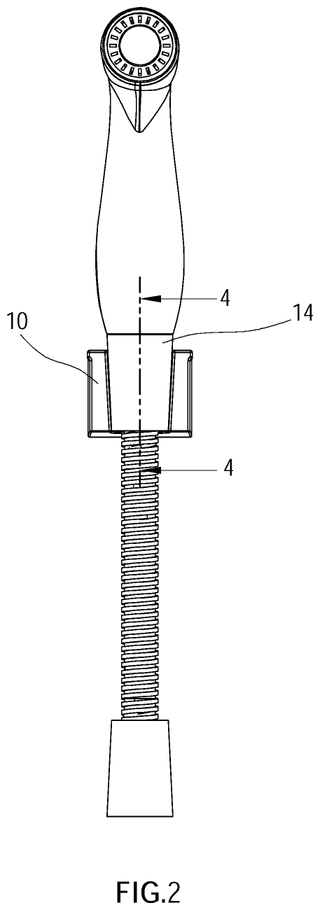

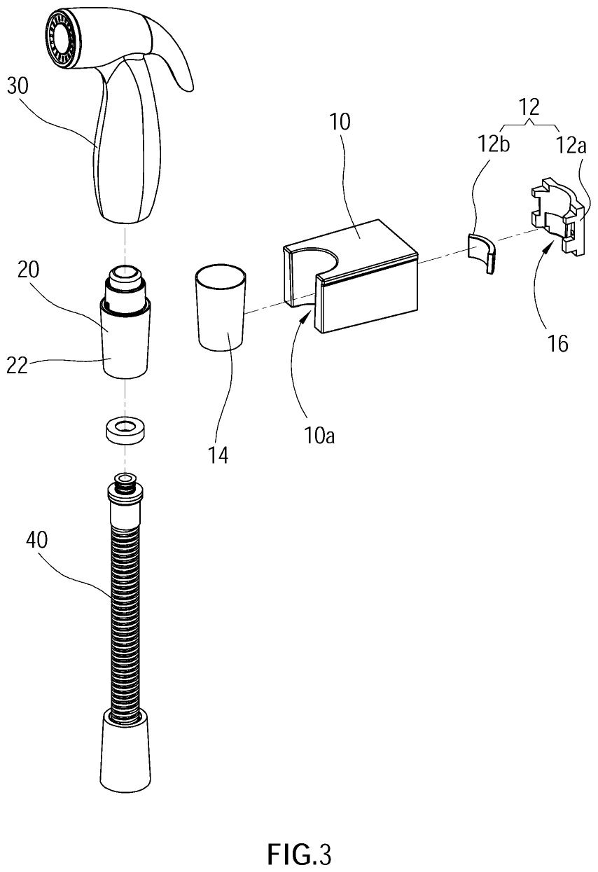

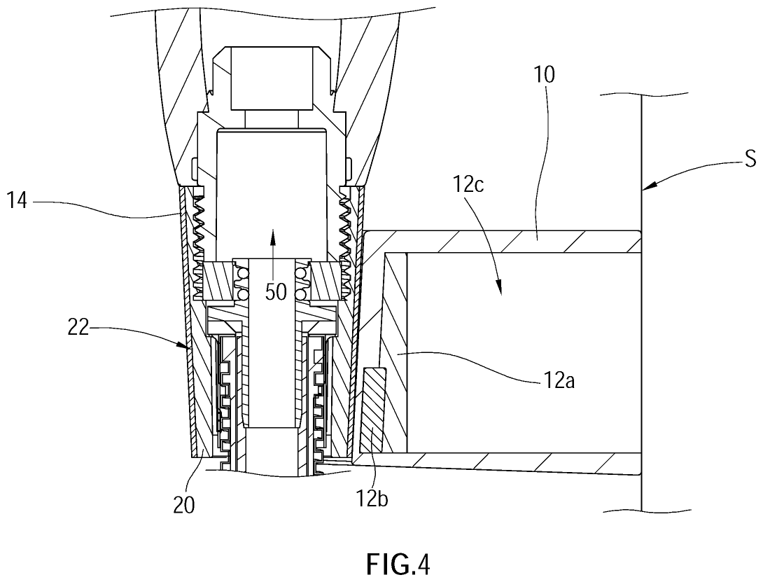

As shown in FIG. 1 to FIG. 10, the first embodiment of the present invention, a fixing structure, is provided.

The fixing structure includes a fixed seat 10, a guiding connection part 20, a flushing head 30, a water supply pipe 40, a first magnetic part 12, and a second magnetic part 14. The guiding connection part 20 has two ends which are opposite to each other, wherein one of the two ends is connected to the flushing head 30, while the other end is connected to the water supply pipe 40, so that the flushing head 30 communicates with the water supply pipe 40 to form a liquid flow path 50. Thus, the flushing head 30 can be controlled by a user to make water flow out. The fixed seat 10 is fixed on a plane, and the first magnetic part 12 is installed on the fixed seat 10, while the second magnetic part 14 is installed on the guiding connection part 20. When the guiding connection part 20 is close to the fixed seat 10, the first magnetic part 12 and the second magnetic part 14 will attract each other with magnetic force. Furthermore, one of the first magnetic part 12 and the second magnetic part 14 is a magnet, while the other one is a magnetic material or another magnet; the materials of the first magnetic part 12 and the second magnetic part 14 are interchangeable.

In this embodiment, the fixed seat 10 has two ends opposite to each other, wherein one of the two ends is provided on a fixed plane S, while the other one has a recess 10a. The first magnetic part 12 is installed on the recess 10a of the fixed seat 10.

Specifically, in this embodiment, the first magnetic part 12 is provided in the fixed seat 10 and on a side adjacent to the recess 10a. Furthermore, the fixed seat 10 includes a cover 12a, an accommodating space 12c, and a magnetic material or magnet 12b provided in the accommodating space 12c, wherein the magnetic material can be a magnetic tile, and the magnetic tile 12b is close to the recess 10a. In this embodiment, the cover 12a is a magnetic tile fixed seat for an explanatory purpose, but is not limited to the magnetic tile fixed seat. The magnetic tile fixed seat 12a is stuffed into the accommodating space 12c so that the magnetic tile 12b is fixedly provided in the accommodating space 12c.

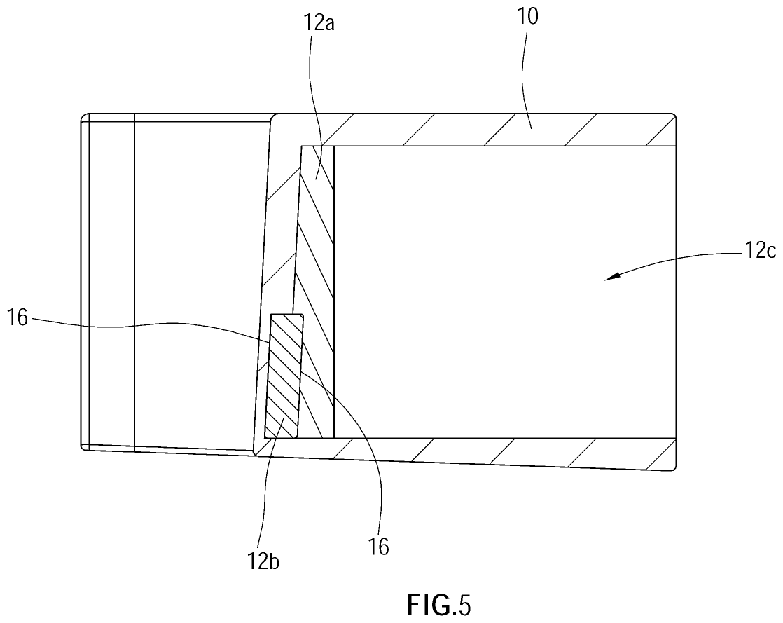

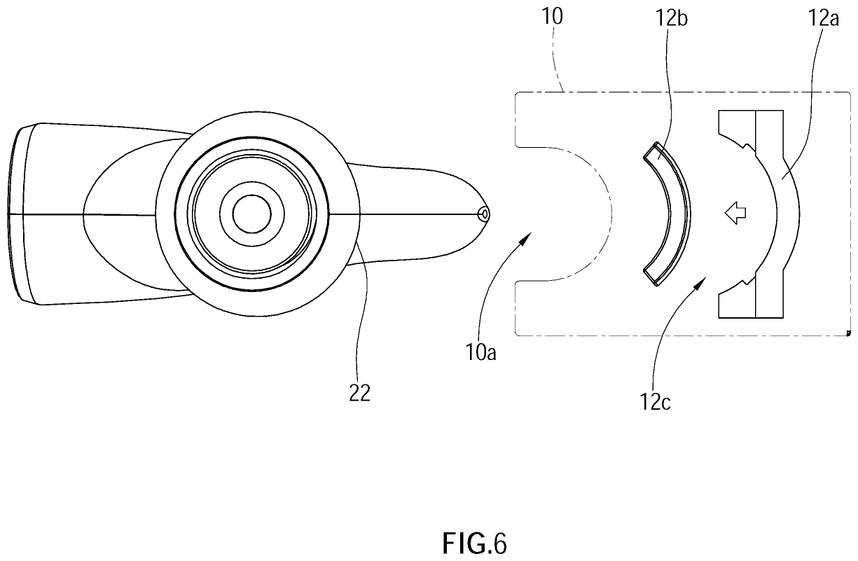

In this embodiment, the magnetic tile 12b is a tile-shaped magnet, and the magnetic tile fixed seat 12a is stuffed into the accommodating space 12c and closely fitted toward the direction of the recess 10a, so that the magnetic tile 12b within the accommodating space 12c can be fixed between the magnetic tile fixed seat 12a and the recess 10a. In order to closely connect the magnetic tile fixed seat 12a and the recess 10a of the fixed seat 10, as well as to reduce the distance between the first magnetic part 12 and the second magnetic part 14, in this embodiment, each of the accommodating space 12c (i.e., interior of the fixed seat 10 close to the recess 10a) and a side of the magnetic tile fixed seat 12a facing the recess has a shallow groove 16. After the magnetic tile fixed seat 12a moves to the end toward the direction of the recess 10a in the accommodating space 12c, the magnetic tile 12b is sandwiched in between the two shallow grooves 16, as shown in FIG. 5 and FIG. 6. Moreover, the guiding connection part 20 is a conical round tube, and the outer diameter of the guiding connection part is reduced from an end connecting the flushing head 30 to an end connecting the water supply pipe 40. In addition, FIG. 6 is a perspective upward view of partial of the first embodiment, which is embodied by an embedded way; the recess 10a, the magnetic tile fixed seat 12a, and the magnetic tile 12b are exploded. The magnetic tile 12b has a curved surface in touch with the recess 10a and the magnetic tile fixed seat 12a, wherein the curvature of the surfaces of the recess 10a and the magnetic tile fixed seat 12a, which are in touch with the curved surface of the magnetic tile 12b, is consistent with the curvature of the curved surface of the magnetic tile 12b. Moreover, the curvature of the surface of the recess 10a matches the curvature of a peripheral surface 22 of the guiding connection part 20.

Besides, according to different conditions or needs, the materials of the magnetic tile 12b and the second magnetic part 14 can be interchanged, which does not affect the function of the fixing structure. Furthermore, the magnetic tile 12b and the magnetic tile fixed seat 12a can be provided on the recess 10a outside the fixed seat 10; similarly, the accommodating space 12c can be formed on the recess 10a outside the fixed seat 10.

The material of the second magnetic part 14 is a magnetic material which includes iron, cobalt, nickel, magnetic stainless steel, or a combination thereof. Moreover, the magnetic material could be a permanent magnet. Said magnetic stainless steel mainly includes models 304, 410, and 430, etc., which have higher chromium content; furthermore, the models generate magnetism due to state changes during heat treatment, processing, or smelting. The second magnetic part 14 is provided on the guiding connection part 20. Thus, when the guiding connection part 20 is close to the recess 10a of the fixed seat 10, the first magnetic part 12 and the second magnetic part 14 can attract each other by magnetic force, which fixes the guiding connection part 20 to the fixed seat 10 detachably so that the flushing device can be fixed to the fixed seat 10.

In the embodiment above, the guiding connection part 20 has an inner surface 24 facing the liquid flow path 50, and the peripheral surface 22 which is opposite to the inner surface 24 and in touch with the fixed seat 10 directly. In this embodiment, the second magnetic part 14 completely covers the peripheral surface 22 of the guiding connection part 20 by injection molding, welding, or other methods. With this design, the area of the second magnetic part 14 can be increased substantially, which increases the range of magnetic attraction. In addition, the appearance of the magnetic tile 12b could be changed, for example, replacing the magnetic material or the magnet from tile shape to arc shape matching with the recess 10a can also achieve the effect of expanding the range of magnetic attraction. In addition, the second magnetic part 14 of the first embodiment covers the guiding connection part 20 in a non-detachable way; however, in other embodiments, the second magnetic part 14 can be detachably installed on the guiding connection part 20. The descriptions of other embodiments are as follows.

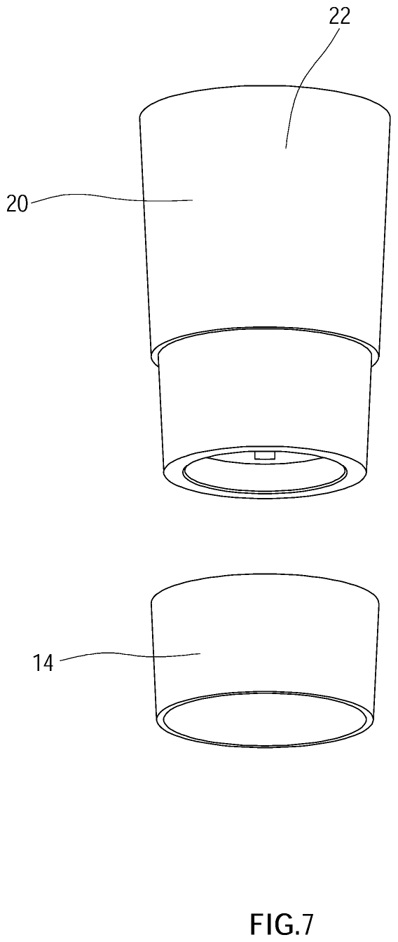

As shown in FIG. 7 to FIG. 10, the second magnetic part 14 of a second embodiment in FIG. 7 is a conically annular body which fits around the peripheral surface 22 of the guiding connection part. With this design, the guiding connection part is more diverse in appearance, and it is easier for users to identify the position and range of action of the magnetic components.

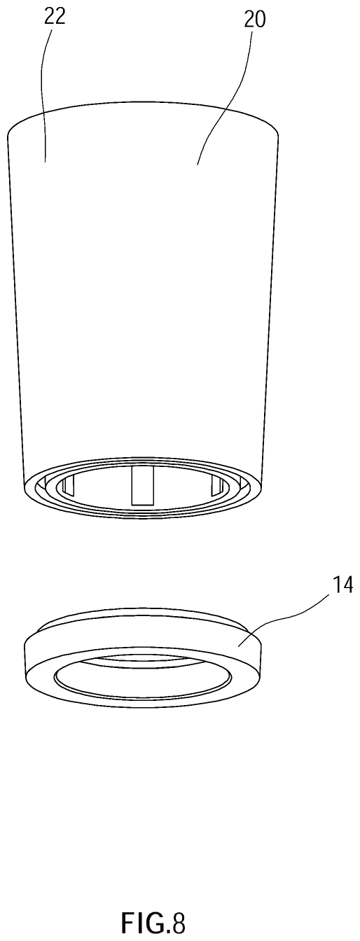

As shown in FIG. 8, the second magnetic part 14 of a third embodiment is ring-shaped and is detachably connected to the bottom perimeter of the guiding connection part 20 by tightly fitting with threads or tolerance. Therefore, product diversity could be increased. For example, the second magnetic part 14 and first magnetic part 12 can be made into optional parts for consumers, so that consumers can purchase the magnetic components separately, and install them to flushing devices which are previously purchased or have no any magnetic components thereon.

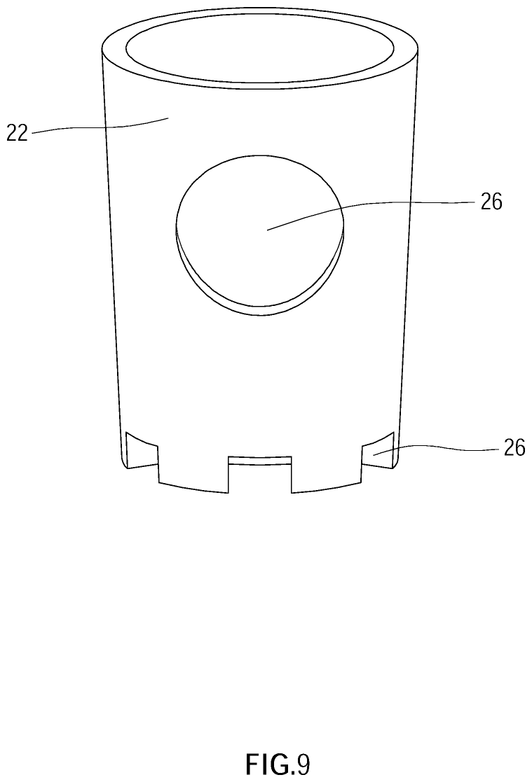

Additionally, as shown in FIG. 9, the peripheral surface 22 of the guiding connection part of a fourth embodiment has at least one notch 26. At least one second magnetic part 14 is embedded in the at least one notch 26 on the peripheral surface 22 of the guiding connection part. If the manufacturer would like to increase the number of the second magnetic part 14 or the position of magnetic action, the manufacturer can shape a plurality of notches 26 on the peripheral surface 22 of the guiding connection part, and then embeds a plurality of second magnetic parts 14 into the notches 26 on the peripheral surface 22 of the guiding connection part. With this design, the guiding connection part can directly approach the fixed seat without rotating to a specific position and be magnetically fixed.

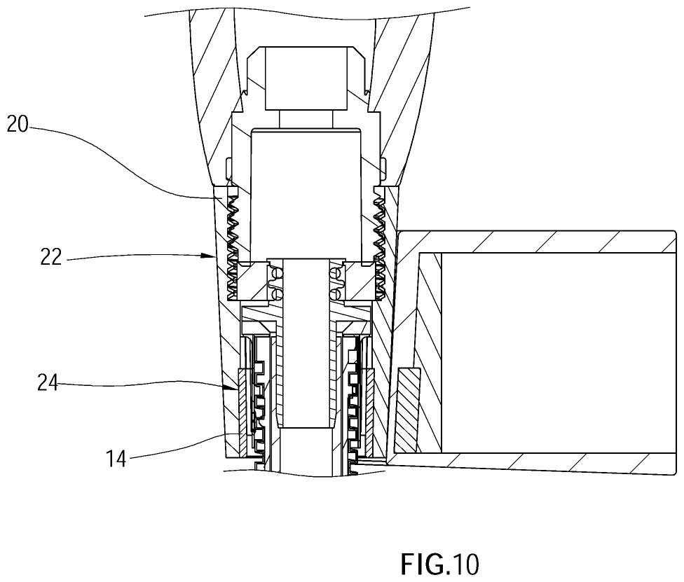

Furthermore, as shown in FIG. 10, the second magnetic part 14 of a fifth embodiment is fixed on an inner surface 24 of the guiding connection part. Thus, the second magnetic part 14 is hidden inside the guiding connection part 20, which makes the overall appearance of the flushing device more neat. Additionally, this design can prevent the magnet or the magnetic components from directly damaged by external force, and reduce the possibility of being rusted by contacting with moisture.

Moreover, the fixing structure of the present invention can be applied to flushing devices including sprinklers, shower heads, spray guns, or combinations thereof, which are commonly used in life.

With the design of the present invention that changes the fixing method of the fixing structure from manual fixing to magnetic fixing, a user can fix the flushing device such as a sprinkler, a shower head, or a cleaner spray gun to the fixed seat easily without exerting a force or visually aligning. Compared with the conventional fixing structure, the present invention has a larger joint range and positioning space, which increases the convenience of use.

It must be noted that the embodiments described above are only preferred embodiments of the present invention. All equivalent structures which employ the concepts disclosed in this specification and the appended claims should fall within the scope of the present invention.

1. A fixing structure for a flushing device, comprising:
a fixed seat having two ends which are opposite to each other, wherein one of the two ends is fixed to a fixed plane, while the other of the two ends has a recess; the fixed seat further comprises a first magnetic part provided on the recess;
the flushing device comprises a guiding connection part and a flushing head, wherein an end of the guiding connection part is connected to the flushing head, while another end of the guiding connection part is connected to a water supply pipe which communicates with the flushing head so that the flushing head can be controlled to make water flow out; the guiding connection part comprises a second magnetic part, and when the guiding connection part of the flushing device is set in the recess of the fixed seat, the second magnetic part and the first magnetic part magnetically attract each other detachably;
wherein one of the first magnetic part and the second magnetic part is a magnet, while the other of the first magnetic part and the second magnetic part is a magnetic material or another magnet, and
wherein the fixed seat further has an accommodating space therein and a cover; the magnet or the magnetic material is provided in the accommodating space and is closer to the recess rather than the fixed plane; the cover is stuffed into the accommodating space so that the magnet or the magnetic material is fixedly provided in the accommodating space and is separated from an outside; a side of the fixed seat in the accommodating space has a shallow groove, and a side of the cover facing the recess also has a shallow groove, and the magnet or the magnetic material is fixed between the two shallow grooves.

2. The fixing structure of claim 1, wherein when the first magnetic part comprises the magnet, and the second magnetic part comprises the magnetic material or the another magnet, the magnet is provided in the recess, and the magnetic material or the another magnet is provided on the guiding connection part, so that the guiding connection part and the recess magnetically attract each other correspondingly in a detachable way.

3. The fixing structure of claim 1, wherein the guiding connection part has an inner surface, and the second magnetic part is fixed to the inner surface.

4. The fixing structure of claim 1, wherein the guiding connection part has a peripheral surface opposite to the inner surface; the second magnetic part covers and is fixed to the peripheral surface.

5. The fixing structure of claim 1, wherein the guiding connection part has a peripheral surface opposite to the inner surface; the second magnetic part is annular and fits around the peripheral surface detachably.

6. The fixing structure of claim 1, wherein the guiding connection part has a peripheral surface opposite to the inner surface; the peripheral surface has at least one notch, and the second magnetic part is embedded in the at least one notch.

7. The fixing structure of claim 1, wherein the magnetic material comprises iron, nickel, cobalt, magnetic stainless steel, or a combination thereof; the magnet comprises a permanent magnet.

8. The fixing structure of claim 1, wherein when the second magnetic part comprises the magnet, and the first magnetic part comprises the magnetic material or the another magnet, the magnet is provided on the guiding connection part, and the magnetic material or the another magnet is provided in the recess, so that the guiding connection part and the recess magnetically attract each other correspondingly in a detachable way.

9. (canceled)

10. (canceled)

11. The fixing structure of claim 1, wherein the flushing device comprises a sprinkler, a shower head, a spray gun, or a combination thereof.
